(19) United States
(12) Patent Application Publication
(10) Pub. No.: US 2021/0033025 A1
(43) Pub. Date: Feb. 4, 2021

(54) PLANT CONTROL APPARATUS, PLANT CONTROL METHOD AND POWER PLANT

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Ibrahim ABDURRAHMAN, Yokohama Kanagawa (JP); Masayuki TOBO, Kawasaki Kanagawa (JP); Toyohiro AKEBI, Inagi Tokyo (JP); Yusuke FUKAMACHI, Higashiyamato Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 16/943,752

(22) Filed: Jul. 30, 2020

(30) Foreign Application Priority Data
Jul. 31, 2019 (JP) 2019-141043

(51) Int. Cl. F02C 6/18; F01D 5/08; F01D 25/12; F01K 7/22; F01K 23/10; F02C 7/143

(52) U.S. Cl. CPC F02C 6/18; F01D 5/081; F01D 25/12; F05D 2220/76; F01K 23/10; F02C 7/143; F05D 2220/72; F01K 7/22

(57) ABSTRACT

In one embodiment, a plant control apparatus controls a power plant. The apparatus includes a gas turbine, an exhaust heat recovery boiler to generate main steam, a first steam turbine driven by first steam, and a first valve to supply the first steam to the first steam turbine. The plant further includes a reheater to generate reheat steam, a second steam turbine driven by second steam, and second and third valves to supply the second steam to the second steam turbine. The apparatus includes an acquisition module to acquire a setting value of total output of the first and second steam turbines, and a control module to adjust the total output to the setting value by controlling opening degrees of the first, second and third valves. The control module controls the second and third valves to different opening degrees when adjusting the total output to the setting value.

### CROSS REFERENCE TO RELATED APPLICATION

This application is based upon and claims the benefit of priority from the prior Japanese Patent Application No. 2019-141043, filed on Jul. 31, 2019, the entire contents of which are incorporated herein by reference.

### FIELD

Embodiments described herein relate to a plant control apparatus, a plant control method and a power plant.

### BACKGROUND

A combined cycle power plant configured by combining a gas turbine, an exhaust heat recovery boiler and a steam turbine is conventionally known. The exhaust heat recovery boiler recovers heat from exhaust gas of the gas turbine to generate steam. The steam turbine is driven by the steam generated by the exhaust heat recovery boiler.

### BRIEF DESCRIPTION OF THE DRAWINGS

FIG. 1 is a schematic diagram illustrating a configuration of a power plant of a first embodiment;

FIG. 2 is a circuit diagram illustrating a configuration of a plant control apparatus of the first embodiment;

FIG. 3 is a schematic diagram illustrating a configuration of a power plant of a second embodiment;

FIG. 4 is a circuit diagram illustrating a configuration of a plant control apparatus of the second embodiment;

FIG. 5 is a schematic diagram illustrating a configuration of a power plant of a comparable example; and

FIG. 6 is a circuit diagram illustrating a configuration of a plant control apparatus of the comparable example.

### DETAILED DESCRIPTION

Several system configuration types of combined cycle power plants are known, and the recent mainstream thereof is a plant using a cascade bypass system. However, the plant using the cascade bypass system has a problem that the exhaust gas temperature of a high-pressure steam turbine rises. A turbine control method that has been used to avoid this problem is 2:1 flow rate control for controlling the steam turbine in such a manner that the ratio of the flow rate of main steam introduced into the high-pressure steam turbine and the flow rate of reheat steam introduced into an intermediate-pressure steam turbine becomes 2:1.

On the other hand, in recent combined cycle power plants, with the increase in size of the steam turbine, it has become necessary to perform a heat soak operation to reduce the thermal stress of the steam turbine when performing cold start while holding the steam turbine in an initial load state. However, performing the heat soak operation while performing the 2:1 flow rate control causes a problem that the amount of steam required to hold the initial load state becomes insufficient. The reason is that the 2:1 flow rate control has an aspect of discharging a great amount of reheat steam to a steam condenser.

In one embodiment, a plant control apparatus is configured to control a power plant. The plant includes a gas turbine, and an exhaust heat recovery boiler configured to generate main steam by using heat of exhaust gas from the gas turbine. The plant further includes a first steam turbine configured to be driven by first steam that is a part of the main steam, a first valve configured to supply the first steam to the first steam turbine, and a first bypass valve configured to adjust first bypass steam that is another part of the main steam and bypasses the first steam turbine. The plant further includes a reheater provided in the exhaust heat recovery boiler and configured to generate reheat steam by heating the first steam discharged from the first steam turbine and the first bypass steam having bypassed the first steam turbine by using heat of the exhaust gas. The plant further includes a second steam turbine configured to be driven by second steam that is a part of the reheat steam, second and third valves configured to supply the second steam to the second steam turbine, and a second bypass valve configured to adjust second bypass steam that is another part of the reheat steam and bypasses the second steam turbine. The apparatus includes an acquisition module configured to acquire a setting value of total output of the first and second steam turbines, and a control module configured to adjust the total output to the setting value by controlling opening degrees of the first, second and third valves. The control module is configured to control the second and third valves to different opening degrees when adjusting the total output to the setting value.

Embodiments will now be explained with reference to the accompanying drawings.

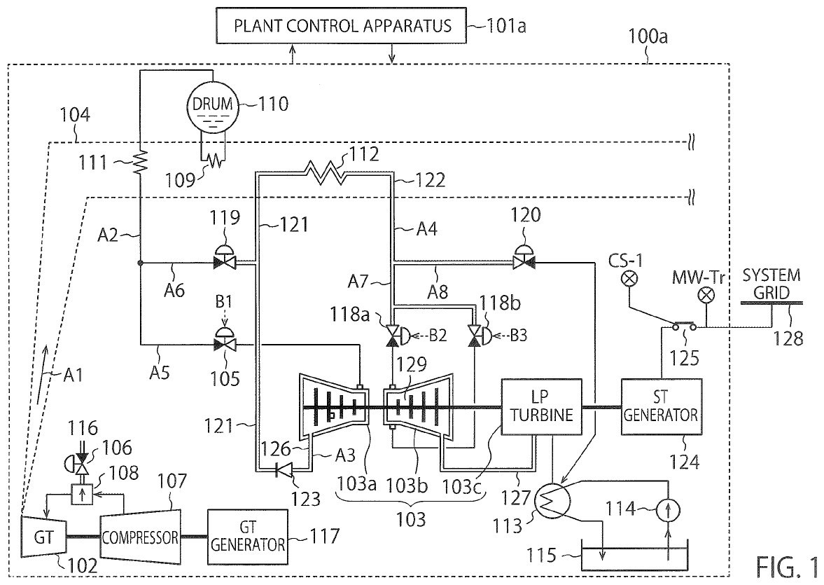

In FIGS. 1 to 6, the same or similar constituent components are denoted by the same reference numerals, and redundant description thereof will not be repeated. Further, regarding various physical quantities and setting values used in the following description, specific numerical values indicating the values of these physical quantities and setting values are mere examples for facilitating the description, and these physical quantities and setting values are not limited to only these numerical values.

### Comparable Example

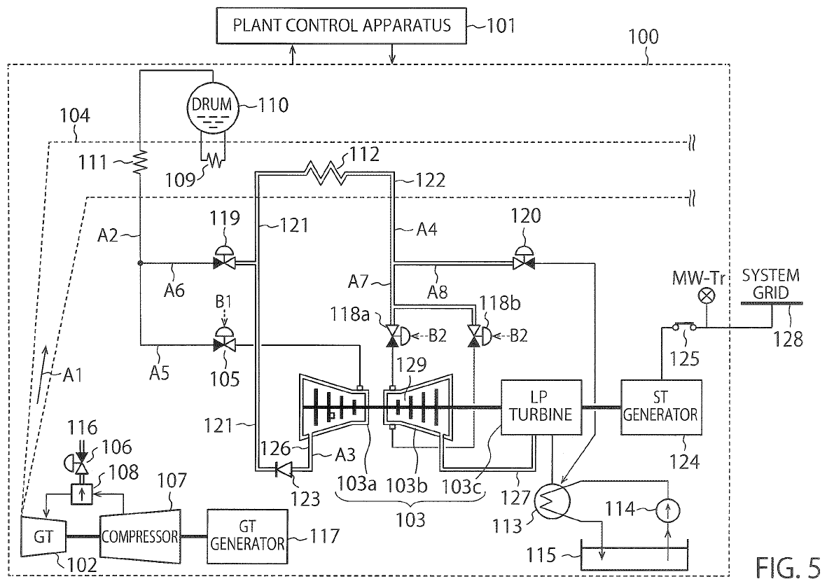

FIG. 5 is a schematic diagram illustrating a configuration of a power plant 100 of a comparable example. The power plant 100 illustrated in FIG. 5 is a separate-shaft combined cycle (C/C) power plant that uses a cascade bypass system.

(1) Power Plant 100 of Comparable Example

The power plant 100 illustrated in FIG. 5 includes a plant control apparatus 101 that controls operations of the power plant 100, and further includes a gas turbine (GT) 102, a steam turbine (ST) 103, an exhaust heat recovery boiler 104, an increase/decrease valve (MCV valve) 105, a fuel control valve 106, a compressor 107, a combustor 108, a vaporizer 109, a drum 110, a superheater 111, a reheater 112, a steam condenser 113, a circulating water pump 114, portions for intaking and draining seawater 115, a portion for supplying fuel 116, a GT generator 117, an intercept valve (ICV valve) 118, a high-pressure turbine bypass control valve 119, an intermediate-pressure turbine bypass control valve 120, a low-temperature reheat pipe 121, a high-temperature reheat pipe 122, a check valve 123, an ST generator 124, a generator breaker 125, a high-pressure turbine exhaust gas pipe 126, a crossover pipe 127, a system grid 128, and a reheat bowl chamber 129.

The steam turbine 103 is configured by a high-pressure (HP) turbine 103a, an intermediate-pressure (IP) turbine 103b, and a low-pressure (LP) turbine 103c. Hereinafter, the intermediate-pressure turbine 103b and the low-pressure turbine 103c may be collectively referred to as “intermediate/low-pressure turbine 103bc”. Further, the power plant 100 includes, as ICV valves 118, an A-ICV valve 118a and a B-ICV valve 118b. The power plant 100 further includes an MW transducer MW-Tr.

The fuel control valve 106 is provided in a fuel pipe. When the fuel control valve 106 is opened, the fuel 116 is supplied into the combustor 108 from the fuel pipe. The compressor 107 introduces air from its inlet and supplies compressed air to the combustor 108. The combustor 108 burns the fuel 116 together with oxygen in the compressed air to generate high-temperature and high-pressure combustion gas.

The power plant 100 illustrated in FIG. 5 is a separate-shaft C/C power plant, in which the gas turbine 102 and the GT generator 117 are fixed to one rotating shaft (rotor) and the steam turbine 103 and the ST generator 124 are fixed to another rotating shaft. The gas turbine 102 is driven by the combustion gas to cause the rotating shaft to rotate. The GT generator 117 is connected to the rotating shaft and generates electric power by using the rotation of the rotating shaft. In this manner, the GT generator 117 is driven by the gas turbine 102. Gas turbine exhaust gas A1 discharged from the gas turbine 102 is sent to the exhaust heat recovery boiler 104. The exhaust heat recovery boiler 104 generates main steam A2, as described below, by using heat of the gas turbine exhaust gas A1.

The vaporizer 109, the drum 110, the superheater 111, and the reheater 112 are provided in the exhaust heat recovery boiler 104 and configure a part of the exhaust heat recovery boiler 104. Water in the drum 110 is sent to the vaporizer 109, and is heated by the gas turbine exhaust gas A1 in the vaporizer 109, so that the water becomes saturated steam. The saturated steam is accumulated in the drum 110. The saturated steam is sent to the superheater 111, and is superheated by the gas turbine exhaust gas A1 in the superheater 111 so that the saturated steam becomes superheated steam. The superheated steam generated by the exhaust heat recovery boiler 104 is discharged, as the main steam A2, to a steam pipe.

The steam pipe is bifurcated into a main pipe and a bypass pipe. The main pipe is connected to the high-pressure turbine 103a, and the bypass pipe is connected to the low-temperature reheat pipe 121. The MCV valve 105 is provided in the main pipe. The high-pressure turbine bypass control valve 119 is provided in the bypass pipe and is connected to the low-temperature reheat pipe 121.

The MCV valve 105, when receiving an opening degree command value B1 [%] from a control circuit (described below) incorporated in the plant control apparatus 101, is opened. When the MCV valve 105 is opened, the main steam A2 from the main pipe (hereinafter, referred to as “MCV inflow steam A5”) is supplied to the high-pressure turbine 103a. The high-pressure turbine 103a is rotationally driven by the MCV inflow steam A5, and at this time, the ST generator 124 is also driven by the high-pressure turbine 103a. Exhaust steam discharged from an exhaust gas port (high-pressure turbine exhaust portion) of the high-pressure turbine 103a (hereinafter, referred to as “high-pressure turbine exhaust steam A3”) is supplied to the reheater 112 via the high-pressure turbine exhaust gas pipe 126 and the low-temperature reheat pipe 121.

On the other hand, when the high-pressure turbine bypass control valve 119 is opened, the main steam A2 from the bypass pipe (hereinafter, referred to as “high-pressure bypass steam A6”) is sent to the low-temperature reheat pipe 121 by bypassing the high-pressure turbine 103a. The high-pressure bypass steam A6 is supplied to the reheater 112 via the low-temperature reheat pipe 121. Here, an exemplary control of the high-pressure turbine bypass control valve 119 will be described schematically. The high-pressure turbine bypass control valve 119 performs pressure control for holding the pressure of the main steam A2 at 7.0 MPa. Since the pressure of the main steam A2 is substantially equal to the internal pressure of the drum 110 (although there is a slight difference in pipe pressure loss), it can be said that the high-pressure turbine bypass control valve 119 performs pressure control for holding the internal pressure of the drum 110 at 7.0 MPa. By performing such a pressure control, the high-pressure turbine bypass control valve 119 can stabilize the pressure of the drum 110.

The check valve 123 is, as illustrated in FIG. 5, provided in the low-temperature reheat pipe 121. The check valve 123, in an opened state, permits the high-pressure turbine exhaust steam A3 to flow from the high-pressure turbine 103a to the reheater 112 and prevents the high-pressure bypass steam A6 from flowing from the high-pressure turbine bypass control valve 119 to the high-pressure turbine 103a. On the other hand, in a closed state, the check valve 123 shuts off both the former steam flow and the latter steam flow.

When the MCV valve 105 is opened as described above, the check valve 123 is also opened. Therefore, the high-pressure turbine exhaust steam A3 discharged from the high-pressure turbine 103a passes through the check valve 123 and is supplied to the reheater 112. On the other hand, when the high-pressure turbine bypass control valve 119 is opened as described above, regardless of the opened or closed state of the check valve 123, the high-pressure bypass steam A6 from the bypass pipe is shut off by the check valve 123 and is not supplied to the high-pressure turbine 103a. In this case, the high-pressure bypass steam A6 from the bypass pipe is supplied to the reheater 112.

One end (hereinafter, referred to as “first end”) of the reheater 112 is connected to the low-temperature reheat pipe 121, and the other end (hereinafter, referred to as “second end”) of the reheater 112 is connected to the high-temperature reheat pipe 122. The reheater 112 takes in the high-pressure turbine exhaust steam A3 and/or the high-pressure bypass steam A6 from the first end and discharges the taken-in steam from the second end.

The reheater 112, by heating the steam from the first end by using the heat of the gas turbine exhaust gas A1, generates reheat steam A4. The reheater 112 discharges the reheat steam A4 from the second end to the high-temperature reheat pipe 122. The high-temperature reheat pipe 122 is bifurcated into a first pipe and a second pipe. The first pipe is further bifurcated into a pipe connected to the A-ICV valve 118a and a pipe connected to the B-ICV valve 118b. The second pipe is connected to the intermediate-pressure turbine bypass control valve 120.

The A-ICV valve 118a and the B-ICV valve 118b receive an opening degree command value B2 [%] from the control circuit (described below) incorporated in the plant control apparatus 101 and are opened at the same opening degree. In this comparable example, the A-ICV valve 118a and the B-ICV valve 118b are the same in size, type, and performance. The A-ICV valve 118a and the B-ICV valve 118b are arranged in parallel with each other between the reheater 112 and the intermediate-pressure turbine 103b. When these ICV valves 118a/118b are opened, “ICV inflow steam A7” flows in the first pipe. Specifically, a half of the ICV inflow steam A7 is supplied, via the A-ICV valve 118a, to an upper part of the reheat bowl chamber 129 in the intermediate-pressure turbine 103b. The remaining half is supplied, via the B-ICV valve 118b, to a lower part of the reheat bowl chamber 129. Two steams, after entering in the reheat bowl chamber 129 from these ICV valves 118a/118b, merge together in the reheat bowl chamber 129 and rotationally drive the intermediate-pressure turbine 103b, and cause the above-described rotating shaft to rotate together with the high-pressure turbine 103a.

As described above, the power plant 100 of the comparable example includes two ICV valves 118, i.e., the A-ICV valve 118a and the B-ICV valve 118b. The reason why the bi-valved ICV valves 118 are provided is because the steam turbine 103 has a large capacity in accordance with an increase in the output of the combined cycle power plant and the flow rate of the steam passing through the ICV valve 118 (the ICV inflow steam A7) also becomes large. That is, as a measure against the large flow, it is technically easier to install small bi-valved ICV valves 118 and divide the large flow into these two valves, rather than installing a large uni-valved ICV valve. As an exemplary case, when the steam turbine 103 is urgently stopped due to facility failure or the like, it is necessary to close the ICV valve as quickly as possible to prevent over-speed of the steam turbine 103. In this case, compared to a large single-valved ICV valve, each of the small bi-valved ICV valves can be quickly closed with a shorter stroke. Therefore, the ICV inflow steam A7 can be quickly shut off to suppress the over-speed within an allowable range.

For comparison, the MCV valve 105 is also referred to. The MCV valve 105 is configured as a single valve even when the steam turbine 103 has a large capacity, and is different from the ICV valves 118 of 2-valve configuration. The above difference is because the MCV inflow steam A5 has a higher steam pressure and has a relatively small amount of volume flow, and accordingly the MCV valve 105 fits in a relatively compact valve body and can be constituted as a single valve. On the other hand, the ICV inflow steam A7 has a lower steam pressure and a larger amount of volume flow, and accordingly the valve body size of the ICV valve 118 originally tends to be large. In other words, there is a situation in which further increase in size is becoming difficult.

Exhaust steam discharged from an exhaust gas port the intermediate-pressure turbine 103b (intermediate-pressure turbine exhaust steam) is supplied from the crossover pipe 127 to the low-pressure turbine 103c. The low-pressure turbine 103c, when rotationally driven by the steam from the crossover pipe 127, causes the above-described rotating shaft to rotate together with the high-pressure turbine 103a and the intermediate-pressure turbine 103b. As a result, the ST generator 124 is driven by the high-pressure turbine 103a, the intermediate-pressure turbine 103b, and the low-pressure turbine 103c. Exhaust steam discharged from an exhaust gas port of the low-pressure turbine 103c (low-pressure turbine exhaust steam) is sent to the steam condenser 113.

On the other hand, when the intermediate-pressure turbine bypass control valve 120 is opened, the reheat steam A4 (hereinafter, referred to as “intermediate-pressure bypass steam A8”) is sent to the steam condenser 113 from the above-described second pipe by bypassing the intermediate/low-pressure turbine 103bc. Here, an exemplary control of the intermediate-pressure turbine bypass control valve 120 will be outlined. The intermediate-pressure turbine bypass control valve 120 performs pressure control for holding the pressure of the reheat steam A4 at 0.8 MPa. Since the pressure of the reheat steam A4 is substantially equal to the internal pressure of the reheater 112 and to the pressure of the high-pressure turbine exhaust steam A3 (although there is a slight pipe pressure loss), it can be said that the intermediate-pressure turbine bypass control valve 120 performs pressure control for holding the internal pressure of the reheater 112 and the pressure of the high-pressure turbine exhaust steam A3 at 0.8 MPa. By performing such a pressure control, the intermediate-pressure turbine bypass control valve 120 can hold the pressure of the high-pressure turbine exhaust steam A3 at a relatively low-pressure of 0.8 MPa, and suppress the temperature of the high-pressure turbine exhaust steam A3 from rising.

The steam condenser 113 cools the low-pressure turbine exhaust steam and the intermediate-pressure bypass steam A8 with seawater 115, thereby causing the cooled steam to condense and return to the condensate. The circulating water pump 114 takes in the seawater 115 from the sea and supplies the taken-in seawater 115 to the steam condenser 113.

The ST generator 124 is connected to an electric power transmission line provided with the generator breaker 125 and the MW transducer MW-Tr, and is connected to the system grid 128 via the electric power transmission line. The electric power generated by the ST generator 124 is transmitted to the system grid 128 via the electric power transmission line. The MW transducer MW-Tr measures the electric power (output) of the ST generator 124, and outputs a measurement result of the electric power to the plant control apparatus 101.

As described above, the power plant 100 illustrated in FIG. 5 includes the pipe (the bypass pipe) that bypasses the high-pressure turbine 103a and the pipe (the second pipe) that bypasses the intermediate/low-pressure turbine 103bc. The high-pressure turbine bypass control valve 119 and the intermediate-pressure turbine bypass control valve 120 are provided in these pipes. Then, a downstream pipe of the high-pressure turbine bypass control valve 119 is connected to the low-temperature reheat pipe 121, and an upstream pipe of the intermediate-pressure turbine bypass control valve 120 is bifurcated from the high-temperature reheat pipe 122. Such a system configuration is called a cascade bypass system, and can be said to be the mainstream of recent C/C power plants.

The plant control apparatus 101 controls various operations of the power plant 100. For example, the plant control apparatus 101 controls the opening/closing and the opening degree of each of the MCV valve 105, the ICV valves 118 (the A-ICV valve 118a and the B-ICV valve 118b), the high-pressure turbine bypass control valve 119, and the intermediate-pressure turbine bypass control valve 120.

(2) Initial Load Heat Soak

Here, a brief description is given for the initial load heat soak.

FIG. 5 illustrates the open/close state of each valve when the initial load heat soak of the steam turbine 103 is performed at cold start of the power plant 100. In FIG. 5, each valve being entirely black is in a “fully closed” state, each valve being entirely white is in a “fully opened” state, and each valve being black and white is in an “intermediately opened” state.

When the steam turbine 103 is started, the surface temperature of a turbine member that comes into contact with the high-temperature MCV inflow steam A5 becomes high, and the inside of the turbine member is maintained at a low-temperature because it is not brought into contact with this inflow steam. Therefore, the thermal stress at the starting time of the steam turbine 103 is generated due to distortion caused by thermal expansion. Since the thermal stress is remarkably generated when the steam turbine 103 is in a cold state, an initial load heat soak operation is performed for the purpose of reducing the thermal stress in the cold start of the steam turbine. Specifically, the steam turbine 103 is operated at an extremely low load corresponding to 5% to 10% of the rated output, and this state is held for a predetermined time. The setting time generally selected as the time for holding the initial load heat soak operation is 60 to 120 minutes. Since the flow rate of the MCV inflow steam A5 required in such an extremely low load state is small, the steam turbine 103 operates in such a way as to continuously receive the MCV inflow steam A5 little by little, and accordingly the thermal stress problem can be suppressed.

In this comparable example, for convenience of explanation, the rated 100% output is 300 MW and the initial load is 10%, namely 30 MW (=300×0.1). When this is described from the viewpoint of power generation, the generator breaker 125 is closed (while the ST generator 124 is being brought into the breaker dose operation) during the initial load heat soak operation, the ST generator 124 generates 30 MW, and 30 MW is transmitted to the system grid 128 via the generator breaker 125.

Further, from the viewpoint of relaxing the thermal stress, consideration is given to the operation of the gas turbine 102. In general, when the temperature of the inflow steam (in this case, the temperature of the main steam A2) is lower, the thermal stress of the steam turbine is reduced and relaxed. Therefore, it is desirable that the temperature of the gas turbine exhaust gas A1 is as low as possible. Accordingly, the gas turbine 102 during the initial load heat soak performs a minimum output operation within an allowable range. As a result, the heat quantity of the exhaust gas A1 supplied to the exhaust heat recovery boiler 104 decreases. Although the temperature of the main steam A2 (the MCV inflow steam A5) is lowered as intended, the flow rate of the main steam A2 (the MCV inflow steam A5) decreases as a side effect. This is the background of a heat quantity shortage problem (described below) in the comparable example.

(3) 2:1 Flow Rate Control

When performing the initial load heat soak of extremely low output (30 MW) in the power plant 100 of the cascade bypass system, there is a tendency that the temperature of the high-pressure turbine exhaust steam A3 increases due to the influence of windage loss (frictional heat) generated at a final-stage moving blade of the high-pressure turbine 103a. Since the initial load heat soak is performed in the order of 60 to 120 minutes, the temperature rise of the high-pressure turbine exhaust steam A3 may continue for such a long time. If the temperature rise of the high-pressure turbine exhaust steam A3 continues for a long time and the temperature rise becomes excessively large, a problem of moving blade damage may arise.

To avoid this temperature rise problem, it is desired to increase the flow rate of the high-pressure turbine exhaust steam A3 so that the windage loss can be reduced. That is, it is effective to increase the flow rate of the MCV inflow steam A5. However, simply increasing the MCV inflow steam A5 causes the steam turbine 103 to operate at an output of 30 MW or more and cannot realize the “initial load heat soak”.

Therefore, during the initial load heat soak operation, the flow rate of the MCV inflow steam A5 is increased, and the output of the intermediate/low-pressure turbine 103bc is reduced so as to cancel the increase in the output of the high-pressure turbine 103a, so that the entire output of the steam turbine 103 becomes 30 MW. Specifically, the opening degree of the ICV valve 118 (the A-ICV valve 118a and the B-ICV valve 118b) is decreased to reduce the flow rate of the ICV inflow steam A7, and the output of the intermediate/low-pressure turbine 103bc is reduced.

Then, the 2:1 flow rate control is for specifically defining the flow rate when reducing the flow rate of the ICV inflow steam A7. Specifically, the ratio of the MCV inflow steam A5 to the flow rate of the ICV inflow steam A7 is set to 2:1 to reduce the flow rate of the ICV inflow steam A7. The ratio of 2:1 belongs to a kind of know-how similar to the experience value of a steam turbine manufacturer. In other words, the ratio of 2:1 is not a ratio obtained by calculating the windage loss (frictional heat) generated at the final-stage moving blade of the high-pressure turbine 103a and calculating the flow rate that can avoid the windage loss. The reason is that calculating on paper the frictional heat and the temperature rise occurring in a complicated twisted moving blade is extremely difficult and there is no way other than depending on the experience value. In the present description, the “calculation on paper” means a program analysis of thermodynamics using an arithmetic machine or a personal computer and includes simulation analysis as an application thereof.

The operation region in which the 2:1 flow rate control is required is not limited to the initial load heat soak (30 MW). When the speed increases toward a rated rotational speed immediately after the steam turbine 103 is ventilated (started), the 2:1 flow rate control is required because the amount of the MCV inflow steam A5 is smaller (the reason is that the torque required for the steam turbine 103 is smaller in the speed-increase phase than in the initial load state). However, the speed increase at the start is a passing point in the start-up phase and terminates within a relatively short period of time. Since the operation that can be performed with a small amount of MCV inflow steam A5 has an advantageous aspect, the shortage in heat quantity of the main steam A2 that is a problem in 2:1 flow rate control described below does not occur in the 2:1 flow rate control during the speed increase at the start. Therefore, in this comparable example and first and second embodiments described below, the 2:1 flow rate control during initial load operation and flow rate control performed by another ratio are performed.

Hereinafter, the 2:1 flow rate control and a related initial load control incorporated in the plant control apparatus 101 of the comparable example will be described in detail.

(4) Plant Control Apparatus 101 of Comparable Example

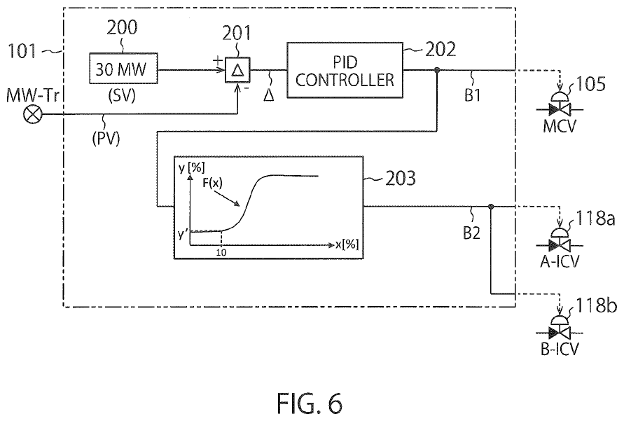

FIG. 6 is a diagram illustrating a control circuit incorporated in the plant control apparatus 101 of the comparable example.

FIG. 6 illustrates a 2:1 flow rate control circuit and a closely related control circuit that realizes the initial load heat soak operation. These circuits are a part of the control circuit incorporated in the plant control apparatus 101. The control circuit illustrated in FIG. 6 includes three valves of MCV valve 105, A-ICV valve 118a, and B-ICV valve 118b.

The control circuit of the plant control apparatus 101 includes, as illustrated in FIG. 6, a setter 200, a subtractor 201, a proportional-integral-derivative (PID) controller 202, and a function generator 203. The high-pressure turbine bypass control valve 119 and the intermediate-pressure turbine bypass control valve 120 are controlled by the plant control apparatus 101, and are not illustrated in FIG. 6 because they are not directly related to the following description.

(4a) Initial Load Control of MCV Valve 105

The MCV valve 105 performs, in a state where the main steam A2 is held at 7.0 MPa and the steam turbine 103 is rotating in synchronism with the system grid 128 while the ST generator 124 is brought into the breaker close operation, the following initial load control.

The setter 200 holds 30 MW, as a setting value (SV value) of electric power that the ST generator 124 generates. As described above, the set value 30 MW is selected as “initial load” in this comparable example and corresponds to a setting value of the total output of the high-pressure turbine 103a, the intermediate-pressure turbine 103b, and the low-pressure turbine 103c.

The subtractor 201 acquires, as a process value (PV value), electric power of the ST generator 124 (hereinafter, referred to as “generator MW”) measured by the MW transducer MW-Tr. Then, the subtractor 201 outputs a deviation Δ by subtracting the process value (PV value) from the generator power setting value 30 MW.

The PID controller 202 of the initial load control acquires the deviation Δ from the subtractor 201, and performs PID control to reduce the deviation Δ to zero. An operation amount (MV value) output from the PID controller 202 is the opening degree command value B1 [%] of the MCV valve 105.

The actual valve opening degree [%] of the MCV valve 105 immediately follows the opening degree command value B1 [%] and is equalized with the opening degree command value B1 [%]. Therefore, in the technical territory to which this comparable example relates, the opening degree command value B1 can be regarded as the opening degree B1 of the MCV valve 105. Hereinafter, notations of the opening degree command value B1 and the opening degree B1 are used together according to the context. Similarly, regarding the A-ICV valve 118a and the B-ICV valve 118b, notations of the opening degree command value B2 and the opening degree B2 are used together according to the context.

Hereinafter, an exemplary operation of the MCV valve 105 when the PID controller 202 outputs the opening degree command value B1 [%] of the MCV valve 105 will be described. When the measured generator MW is smaller than 30 MW, the polarity of A turns to positive and the operation amount (MV value) increases. As a result, the opening degree B1 of the MCV valve 105 increases, the MCV inflow steam A5 increases, and the output of the high-pressure turbine 103a increases. On the other hand, when the generator MW is greater than 30 MW, the polarity of A turns to negative, and the operation amount (MV value) decreases. As a result, the opening degree B1 decreases, the MCV inflow steam A5 decreases, and the output of the high-pressure turbine 103a decreases.

In this way, the MCV valve 105 is adjusted to the opening degree B1 at which the MCV inflow steam A5 sufficient to obtain the generator MW of 30 MW flows in. In the initial load heat soak operation, the 30 MW operation is continued for a predetermined heat soak time (60 to 120 minutes). The control circuit incorporated in the plant control apparatus 101, called a mismatch chart, performs the selection and management of the heat soak time.

(4b) 2:1 Flow Rate Control of ICV Valve

In this comparable example, the A-ICV valve 118a and the B-ICV valve 118b are controlled to have the same opening degree B2. Accordingly, for convenience of explanation, the A-ICV valve 118a and the B-ICV valve 118b are collectively described as “ICV valve 118a/b” in the following description.

The purpose of the 2:1 flow rate control is to reduce the opening degree of the ICV valve 118a/b so that the flow rate of the ICV inflow steam A7 becomes a half of the MCV inflow steam A5. However, even when “B1÷2”, which is a half of the opening degree “B1” of the MCV valve 105 is calculated and the ICV valve 118a/b is opened with the opening degree “B1÷2”, the 2:1 flow rate control may not be realized. That is, even if the opening degree of the ICV valve 118a/b is simply set to a half of the opening degree of the MCV valve 105, the flow rate of steam passing through the ICV valve 118a/b does not become a half of the flow rate of steam passing through the MCV valve 105. The reason is that the MCV valve 105 and the ICV valve 118a/b are different from each other in valve size, flow coefficient (Cv value), and valve characteristic curve. In addition, the differential pressure across the valve body of each valve is not taken into consideration. The amount of steam passing through each valve depends on the differential pressure across the valve body. Therefore, the plant control apparatus 101 of the comparable example includes the function generator 203 that performs 2:1 pressure control.

The function generator 203 acquires the opening degree command value B1 of the MCV valve 105 from the PID controller 202 of the initial load control, and calculates an output y using a function F(x) incorporated therein. An input x input to the function generator 203 is the opening degree command value B1 of the MCV valve 105, and the output y output from the function generator 203 is the opening degree command value B2 of the ICV valve 118a/b. As described above, regarding the ICV valve 118a/b, the notations of the opening degree command value B2 and the opening degree B2 are used together according to the context.

When the opening degree B1 of the MCV valve 105 is input, the function F(x) outputs the opening degree B2 of the ICV valve 118a/b in such a way as to enable the ICV inflow steam A7 to pass through at the flow rate comparable to a half of the flow rate of the MCV inflow steam A5. In this comparable example, since the opening degree of the A-ICV valve 118a and the opening degree of the B-ICV valve 118b are the same, the inflow rate of the A-ICV valve 118a is comparable to ¼ of the MCV inflow steam A5 and the inflow rate of the B-ICV valve 118b is comparable to ¼ of the MCV inflow steam A5. The sum of these inflow rates is comparable to a half of the MCV inflow steam A5. The function F(x) can be obtained in the following manner using the pressure drop heat balance of a stage in the steam turbine 103.

For example, information on primary pressure of the MCV valve 105, high-pressure turbine exhaust gas pressure, Cv value of the MCV valve 105, and temperature of the main steam A2 is required to obtain the flow rate of the MCV inflow steam A5 when the opening degree B1 of the MCV valve 105 is 10 [%]. However, the primary pressure (7.0 MPa) of the MCV valve 105, the high-pressure turbine exhaust gas pressure (0.8 MPa), and the Cv value of the MCV valve 105 are determined or grasped in advance, and the temperature of the main steam A2 can be assumed. Therefore, using these values in calculating the pressure drop at the stage in the high-pressure turbine (including convergent calculation) can obtain the flow rate of the MCV inflow steam A5. A flow rate obtainable by calculating a half of the flow rate of the MCV inflow steam A5 is determined as the flow rate of the ICV inflow steam A7.

Next, the calculation of an opening degree B2′ of the ICV valve 118a/b (=y′) when the stream of the ICV inflow steam A7 passes through will be started. In this case, the primary pressure (0.8 MPa) of the ICV valve 118a/b and the Cv value of the ICV valve 118a/b are determined or grasped in advance, and the low-pressure turbine exhaust gas pressure (almost vacuum pressure similar to the pressure in the steam condenser 113) and the temperature of the reheat steam A4 can be assumed. Therefore, using these values in calculating the pressure drop at the stage in intermediate/low-pressure turbine (including convergent calculation) can obtain y′.

In this way, one coordinate value (10, y′) of the function F(x) is determined. Repeating this procedure, while selecting some values with respect to the opening degree within a range of x (=B1) from 0 [%] to 100 [%] can determine a plurality of coordinate values of the function F(x). Undetermined coordinates existing between these determined coordinates can be approximated by interpolation. As a result, the entire function F(x) can be determined as a setting curve.

As apparent from the above description, a complicated and laborious work is required to determine the function F(x) of the 2:1 flow rate control in this comparable example. Hereinafter, practical operations will be described. The opening degree B2 of the ICV valve 118a/b is linked with the opening degree B1 of the MCV valve 105. Therefore, in the above-described initial load control, when the generator MW is less than 30 MW and the opening degree B1 of the MCV valve 105 increases, the opening degree B2 of the ICV valve 118a/b increases and the output of the intermediate/low-pressure turbine 103bc also increases. That is, by the effects brought by the MCV valve 105 and the ICV valve 118a/b linked with each other, when the generator MW is equal to or less than 30 MW, the entire steam turbine 103 appropriately responds so as to increase the output. On the other hand, when the generator MW is equal to or greater than 30 MW, the opening degree B1 of the MCV valve 105 decreases, and the opening degree B2 of the ICV valve 118a/b also decreases. The output of the entire steam turbine 103 decreases in response to the load.

Then, as described above, the flow rate of the ICV inflow steam A7 is adjusted to a half of the flow rate of the MCV inflow steam A5, even in these cases. As understood from the above description, the 2:1 flow rate control is the control for limiting the opening degree B2 of the ICV valve 118a/b. As a result of reducing the opening degree of the ICV valve 118a/b, surplus reheat steam A4 that cannot flow into the intermediate-pressure turbine 103b is generated. However, this raises the pressure of the reheat steam A4 to 0.8 MPa or more. As a result, the pressure control of the intermediate-pressure turbine bypass control valve 120 becomes active, and the reheat steam A4 is discharged, as the intermediate-pressure bypass steam A8, to the steam condenser 113.

The intermediate-pressure bypass steam A8 is discharged to the steam condenser 113 without contributing to the rotational driving of the intermediate/low-pressure turbine 103bc. Therefore, the high-pressure turbine 103a can maintain a relatively high output even when the operation under the extremely low output of 30 MW is performed as intended. This means that the MCV inflow steam A5 has a relatively high flow rate, so that the temperature rise of the high-pressure turbine exhaust steam A3 is relaxed.

(5) Problem of Comparable Example

During the initial load heat soak, since the gas turbine 102 performs the minimum output operation within an allowable range to hold the exhaust gas A1 at the lowest temperature, the generated flow rate of the main steam A2 is small. Under such an operating situation, if the initial load control increases the opening degree B1 of the MCV valve 105 to hold 30 MW, there is a problem that the high-pressure turbine bypass control valve 119 is fully closed (or extremely slightly opened at 5% or less). Specifically, when the opening degree 131 increases, the MCV inflow steam A5 increases correspondingly. As a result, the pressure control of the high-pressure turbine bypass control valve 119 decreases the opening degree of the high-pressure turbine bypass control valve 119 to hold the main steam pressure at 7.0 MPa. However, since the generated flow rate of the main steam A2 is small, the high-pressure turbine bypass control valve 119 is extremely slightly opened. The valve differential pressure causes erosion. In the worst case, the high-pressure turbine bypass control valve 119 is fully closed, and the pressure control function of the drum 110 is lost.

In this abnormal state, the power plant 100 cannot operate stably. The cause is that the generated flow rate of the main steam A2 is small and the heat quantity from the exhaust heat recovery boiler 104 is insufficient. On the other hand, the 2:1 flow rate control is an operating method for discharging a considerable amount of intermediate-pressure bypass steam A8 (heat quantity) to the steam condenser 113. Therefore, there is no sufficient driving force obtainable from the intermediate/low-pressure turbine 103bc, which worsens the shortage of heat quantity.

Here, consideration is given to a 1:1 flow rate control (in which the ICV inflow steam A7 and the MCV inflow steam A5 are comparable in the flow rate) instead of the 2:1 flow rate control. In this case, since the intermediate/low-pressure turbine 103bc is driven by a great amount of ICV inflow steam A7, a sufficient amount of driving force can be held. Even when the heat quantity of the main steam A2 tends to be insufficient, the output of 30 MW can be maintained without difficulty. Therefore, the 1:1 flow rate control does not encounter with the problem that the high-pressure turbine bypass control valve 119 is slightly opened or fully closed (the heat quantity shortage problem). However, in the 1:1 flow rate control, the flow rate of the MCV inflow steam A5 is small. Therefore, the temperature rise of the high-pressure turbine exhaust steam A3 may become a problem. In short, the temperature rise problem occurring in the high-pressure turbine exhaust steam A3 and the heat quantity shortage problem occurring in the main steam A2 are contradictory phenomena.

### First Embodiment

(1) Overview of First Embodiment

The 2:1 flow rate control described in the comparable example is required when the steam turbine 103 is ventilated (started) and the speed increases toward a rated rotational speed. This is because the amount of MCV inflow steam A5 is small in the speed-increase phase. However, since the amount of the MCV inflow steam A5 in the initial load is greater than that in the speed-increase phase, the temperature rise of the high-pressure turbine exhaust steam A3 is relatively moderated, and an operating method that falls within a range between the 2:1 flow rate control and the 1:1 flow rate control is established (at least there is a possibility).

The present embodiment uses, to realize the above, two ICV valves 118a/b. Specifically, the 2:1 flow rate control is applied to the A-ICV valve 118a like the comparable example, but the opening degree of the B-ICV valve 118b is fixed to a constant opening degree (e.g., 15%) to perform an initial load operation. At this time, setting the fixed opening degree of the B-ICV valve 118b to be greater than the opening degree of the A-ICV valve 118a can realize the operation that falls within the range between the 2:1 flow rate control and the 1:1 flow rate control. In short, since the fixed opening degree increases the output of the intermediate/low-pressure turbine 103bc, the operation at the initial load of 30 MW becomes possible even when the heat quantity of the main steam A2 is insufficient.

When two ICV valves 118a/b are opened at different opening degrees, an unbalanced amount of steam inflow occurs in the up-and-down direction of the reheat bowl chamber 129. However, this does not hinder the turbine operation. This is because, in a steam turbine having a uni-valved ICV valve, the ICV inflow steam is supplied only from above (or only from below) the reheat bowl chamber 129, but this does not hinder the turbine operation. The steam turbine, when having a uni-valved ICV valve, is comparable to the steam turbine includes two ICV valves 118a/b in a state where one ICV valve is fully closed. In light of this, it is apparent that there is no problem when two ICV valves 118a/b are opened at different opening degrees.

(2) Power Plant 100a of First Embodiment

FIG. 1 is a schematic diagram illustrating a configuration of a power plant 100a of the first embodiment.

The power plant 100a illustrated in FIG. 1 includes a plant control apparatus 101a that controls operations of the power plant 100a, and further includes constituent components (gas turbine 102, steam turbine 103, exhaust heat recovery boiler 104, and the like) similar to those of the power plant 100 illustrated in FIG. 5. The power plant 100a illustrated in FIG. 1 further includes a detector CS-1 that detects a “closed-circuit” state of the generator breaker 125. In addition, the plant control apparatus 101a illustrated in FIG. 1 includes a control circuit that performs a flow rate control that is different from the 2:1 flow rate control of the plant control apparatus 101 illustrated in FIG. 5. Therefore, in FIG. 1, the opening degree command [%] of the B-ICV valve 118b is “B3” that is replaced from “B2”.

(3) Plant Control Apparatus 101a of First Embodiment

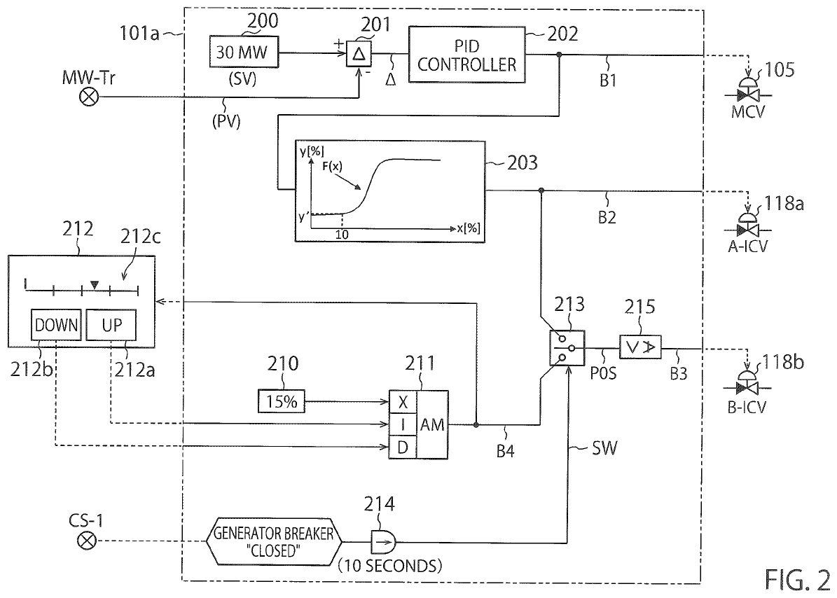

FIG. 2 is a diagram illustrating an exemplary control circuit incorporated in the plant control apparatus 101a of the first embodiment.

The control circuit illustrated in FIG. 2 includes three valves of MCV valve 105, A-ICV valve 118a, and B-ICV valve 118b. Like the control circuit of the plant control apparatus 101, the plant control apparatus 101a includes a setter 200, a subtractor 201, a PID controller 202, and a function generator 203. The plant control apparatus 101a further includes a setter 210, an analog memory 211, an input device 212, a switcher 213, a delay timer 214, and a change rate limiter 215. The input device 212 includes a push button 212a, a push button 212b, and a display device 212c. The MCV valve 105 is an example of a first valve, the A-ICV valve 118a is an example of a second valve, and the B-ICV valve 118b is an example of a third valve. Further, a high-pressure turbine 103a is an example of a first steam turbine. An intermediate-pressure turbine 103b and a low-pressure turbine 103c are an example of a second steam turbine.

A high-pressure turbine bypass control valve 119 and an intermediate-pressure turbine bypass control valve 120 perform controls that are similar to those of the comparable example. That is, the high-pressure turbine bypass control valve 119 performs a pressure control for holding the pressure of the main steam A2 at 7.0 MPa, and the intermediate-pressure turbine bypass control valve 120 performs a pressure control for holding the pressure of the reheat steam A4 at 0.8 MPa. These valves are not directly relevant to the following description although they are controlled by the plant control apparatus 101a, and therefore these valves are not illustrated in FIG. 2. The high-pressure turbine bypass control valve 119 is an example of a first bypass valve, and the intermediate-pressure turbine bypass control valve 120 is an example of a second bypass valve.

(3a) Initial Load Control of MCV Valve 105

The control of the MCV valve 105 is similar to that of the comparable example. That is, the PID controller 202 acquires the deviation Δ from the subtractor 201 and performs PID control to reduce the deviation Δ to zero. The operation amount output from the PID controller 202 is the opening degree command value B1 of the MCV valve 105. Like the comparable example, the notations of the opening degree command value B1 and the opening degree B1 are used together or regarded as being identical according to the context. The MCV valve 105 performs MW control for holding (adjusting) the generator MW at 30 MW. The plant control apparatus 101a, when performing the function for acquiring the setting value of 30 MW from the setter 200, is an example of an acquisition module, and the PID controller 202 is an example of a control module.

(3b) 2:1 Flow Rate Control of A-ICV Valve 118a

The control of the A-ICV valve 118a is similar to that of the comparable example. That is, the function generator 203 acquires the opening degree command value B1 of the MCV valve 105 from the PID controller 202 of the initial load control, and calculates the output y using the function F(x) incorporated therein. An input x input to the function generator 203 is the opening degree command value B1 of the MCV valve 105, and the output y output from the function generator 203 is an opening degree command value B2 of the A-ICV valve 118a. The opening degree command value B2 is bifurcated and used also in a circuit of the B-ICV valve 118b described below. The notations of the opening degree command value B2 and the opening degree B2 are used together or regarded as being identical according to the context.

A function F(x) of the present embodiment is the same function as the function F(x) of the comparable example. Therefore, the opening degree command value B2 generated from the function F(x) of the present embodiment is the opening degree at which the inflow rate of the A-ICV valve 118a is comparable to ¼ of the MCV inflow steam A5, and is linked to the opening degree B1 of the MCV valve 105. Therefore, in the above-described initial load control, when the generator MW is smaller than 30 MW and the opening degree B1 of the MCV valve 105 increases, the opening degree B2 of the A-ICV valve 118a increases and the output of the intermediate/low-pressure turbine 103bc also increases. On the other hand, when the generator MW is equal to or greater than 30 MW, the opening degree B1 decreases and the opening degree B2 of the A-ICV valve 118a also decreases. As a result, the output of the intermediate/low-pressure turbine 103bc decreases.

(3c) Fixed Opening Degree of B-ICV Valve 118b

(α) 2:1 Flow Rate Control for 10 Seconds after Brought into the Breaker Close Operation

First, the switcher 213 will be described. The switcher 213 switches, for controlling the B-ICV valve 118b, between outputting the opening degree command value B2 and outputting an opening degree command value (fixed opening degree) B4 described below. Even in the present embodiment, there is an operation region where the 2:1 flow rate control of the B-ICV valve 118b is required. For this reason, the switcher 213 is provided. An example of such an operation region is the above-described phase in which the speed is increased to the rated rotational speed immediately after the steam turbine 103 is ventilated (started).

Then, after the generator breaker 125 is closed following the rated rotational speed operation (while the ST generator 124 is brought into the breaker close operation), in the stage where the output is increasing to the initial load of 30 MW (before reaching the initial load of 30 MW), the amount of the MCV inflow steam A5 is still relatively small. Therefore, at this time, the 2:1 flow rate control is required. The period in which the 2:1 flow rate control is required is approximately 10 seconds immediately after the generator breaker 125 is closed (brought into the breaker close operation). To determine this, when the detector CS-1 in the plant control apparatus 101a detects the “closed-circuit” state of the generator breaker 125, the delay timer 214 counts up 10 seconds, and when the period of 10 seconds has elapsed, a signal SW from the delay timer 214 turns into ON from OFF.

The following two are input to the switcher 213. That is, these two inputs are the opening degree command value B2 output and bifurcated from the function generator 203 and the fixed opening degree B4 described below. The switcher 213 is configured to switch between these two inputs and output the selected input as an output POS in response to ON/OFF of the signal SW. When the signal SW is ON, the output POS becomes the fixed opening degree B4. When the signal SW is OFF, the output POS becomes the opening degree command value B2. Since the signal SW is OFF for 10 seconds immediately after brought into the breaker close operation, the output POS is the opening degree command value B2.

The change rate limiter 215 receives the output POS, adjusting it, and outputs the adjusted output POS. Specifically, the change rate limiter 215 performs change rate limiting processing on the output POS so that the output of the change rate limiter 215 does not change suddenly. Subsequently, the change rate limiter 215 outputs the output POS having been subjected to the change rate limiting processing as opening degree command value B3. Therefore, for 10 seconds after brought into the breaker close operation, the opening degree command value B3 follows the opening degree command value B2 with slight delay (due to the influence of limiting the change rate), and eventually becomes equal to the opening degree command value B2. That is, for 10 seconds after brought into the breaker close operation, the B-ICV valve 118b is also controlled by the 2:1 flow rate control, and the A-ICV valve 118a and the B-ICV valve 118b have the same opening degree B2.

(β) Heat Quantity Shortage Problem (Re-Description)

Here, the heat quantity shortage problem (i.e., the problem occurring in the comparable example) will be described again. If the generator MW reaches 30 MW using the same operating method as the comparable example, the operation state is as follows. The MCV valve 105 is controlled by the initial load control to be opened at the opening degree B1, and the opening degree B1 becomes an “opening degree P” at 30 MW. As both the A-ICV valve 118a and the B-ICV valve 118b are controlled by the 2:1 flow rate control to be opened at the opening degree B2, and the opening degree B2 becomes an “opening degree Q” at 30 MW. Practical values of the opening degree P and the opening degree Q are variable depending on turbine model type, temperature/pressure of the main steam A2, and the like. However, from experiences, it is assumed that the opening degree P is between about 11% to 15% and the opening degree Q is between about 6% to 10%.

When the opening degree P is used, the shortage of heat quantity is described in the following manner. The cause of heat quantity shortage is that the opening degree P of the MCV valve 105 becomes relatively high. As a result, most (or all) of the main steam A2 flows into the MCV valve 105 as the MCV inflow steam A5. As a result, the opening degree of the high-pressure turbine bypass control valve 119 is slightly opened (or fully closed). This operation state, since the pressure control of the drum 110 is lost, may hinder stable operations.

(γ) Fixed Opening Degree after Elapse of the Breaker Close Operation of 10 Seconds

Therefore, in the present embodiment, the fixed opening degree of the B-ICV valve 118b is set to 15% at the time when 10 seconds have elapsed after brought into the breaker close operation (before reaching 30 MW). In this case, the fixed opening degree needs to be selected as an opening degree greater than the opening degree Q of the A-ICV valve 118a, and 15% is an example. The reason why the fixed opening degree is set to be greater than the opening degree Q is to increase the output of the intermediate/low-pressure turbine 103bc and decrease the output of the high-pressure turbine 103a. However, if the fixed opening degree is set to an extremely large opening degree, only the output of the intermediate/low-pressure turbine 103bc exceeds 30 MW, and a problem that the MCV valve 105 is fully closed arises. Therefore, the fixed opening degree is required to be appropriately larger than the opening degree Q. The final numerical value of the fixed opening degree is optimized through a “trial approach” described below.

To provide this fixed opening degree, the setter 210 and the analog memory 211 are provided. The analog memory 211 is one of various types of integrators, and is configured to be manually operable to increase or decrease. The analog memory 211 is provided, at an input part thereof, with X, I, and D ports.

Since the setting value in the setter 210 is 15%, the X port of the analog memory 211 acquires 15% from the setter 210 and outputs the acquired value as the fixed opening degree B4. The setting value 15% is understood to be a value corresponding to the initial value of the integrator. Further, the analog memory 211 can increase and decrease the fixed opening degree B4 from the initial value 15% in response to a manual operation input from the I port or the D port, as described below in the following item (δ).

As described above, the signal SW is turned into ON at the time when 10 seconds have elapsed after brought into the breaker close operation, the output POS of the switcher 213 is switched to the fixed opening degree B4. The fixed opening degree B4 is input to the change rate limiter 215, and the opening degree command value B3 output from the change rate limiter 215 increases at a predetermined change rate to 15%. Correspondingly, the opening degree of the B-ICV valve 118b becomes 15%. Regarding the opening degree command value B3, the notations of the opening degree command value B3 and the opening degree B3 are used together or regarded as being identical according to the context.

As described above, the plant control apparatus 101a of the present embodiment controls the two ICV valves 118a/b to have different opening degrees in a predetermined period. During this period, the opening degree of the A-ICV valve 118a and the opening degree of the B-ICV valve 118b may be controlled to constantly have different opening degrees or temporarily have the same opening degree. For example, when the fixed opening degree B4 is 15%, the opening degree of the A-ICV valve 118a during the above period may be constantly other than 15% or may temporarily become 15%.

This is the same when the value of the fixed opening degree B4 is 13% or 14% as described below. For example, when the fixed opening degree B4 is 14%, the opening degree of the A-ICV valve 118a during the above period may be constantly other than 14% or may temporarily become 14%.

Hereinafter, an exemplary operation at the fixed opening degree B4 of 15% will be described. In this case, since the opening degree B3 of the B-ICV valve 118b increases to 15%, the output of the intermediate/low-pressure turbine 103bc increases. As a result, when the steam turbine 103 reaches 30 MW, the required output of the high-pressure turbine 103a is smaller than that of the comparable example. That is, by the initial load control, the opening degree B1 of the MCV valve 105 is reduced from the opening degree P. Correspondingly, the opening degree B2 of the A-ICV valve 118a (under the 2:1 flow rate control) is also reduced from the opening degree Q. However, the opening degree B3 of the B-ICV valve 118b is no longer linked with these changes and holds the fixed opening degree of 15%. Letting the opening degree of the MCV valve 105 become smaller than the opening degree P can eliminate or moderate the high opening degree of the MCV valve 105, which was the cause of the heat quantity shortage problem occurring in the comparable example. As a result, the MCV inflow steam A5 decreases, and the high-pressure turbine bypass control valve 119 recovers (increases its opening) to the opening degree at which the pressure control can be performed stably.

The above operation is described again referring to the concept of virtual initial load control. First, the output of the intermediate/low-pressure turbine 103bc is divided into an output generated by the steam having passed through the A-ICV valve 118a (hereinafter, referred to as intermediate-low TBN output (A)) and an output generated by the steam having passed through the B-ICV valve 118b (hereinafter, referred to as intermediate-low TBN output (B)). Needless to say, when the opening degree of the B-ICV valve 118b is kept at 15%, the intermediate-low TBN output (B) also becomes constant (strictly speaking, when the opening degree of the A-ICV valve 118a changes, the intermediate-low TBN output (B) slightly changes due to the influence of stage pressure difference in the turbine, but the intermediate-low TBN output (B) can be regarded as being constant because such a change is neglectable in the technical territory of the present embodiment). For convenience of explanation, the above constant output is assumed to be 12 MW. In this case, since the intermediate-low TBN output (B) remains constant at 12 MW, additional 18 MW may be complemented by both the output of the high-pressure turbine 103a and the intermediate-low TBN output (A), so that the generator MW becomes the initial load of 30 MW.

That is, the initial load control for the MCV valve 105 may be virtually performed by the MW control using 18 MW as a setting value instead of 30 MW. In this virtual initial load control, the opening degree B1 of the MCV valve 105 is reduced so as to realize the output of 18 MW, and the A-ICV valve 118a (under the 2:1 flow rate control) is reduced in conjunction therewith. In this virtual initial load control, 12 MW of the intermediate-low TBN output (B) is regarded as a constant bias value.

What has been realized here is the above-described operation that falls within the range between the 2:1 flow rate control and the 1:1 flow rate control. The inflow rate of the A-ICV valve 118a under the 2:1 flow rate control is comparable to ¼ of the MCV inflow steam A5. Since the opening degree of 15% of the B-ICV valve 118b is greater than that of the A-ICV valve 118a, the inflow rate of the B-ICV valve 118b is comparable to ¼ of the MCV inflow steam A5 or more. Accordingly, the total flow rate of two ICV valves 118a/b, that is, the flow rate of the ICV inflow steam A7, is equal to or greater than ½ of the MCV inflow steam A5. The flow rate ratio becomes smaller than 2:1. In addition, since the intermediate-pressure turbine bypass control valve 120 is intermediately opened as described below, the flow rate ratio becomes greater than 1:1. That is, the flow rate ratio is between 2:1 and 1:1.

At this time, the behavior and operations of the intermediate-pressure turbine bypass control valve 120 are as follows. When the opening degree of the B-ICV valve 118b is increased to 15%, the output of the intermediate/low-pressure turbine 103bc increases. The increased amount is brought because (a part of) the intermediate-pressure bypass steam A8 that has previously flowed into the steam condenser 113 via the intermediate-pressure turbine bypass control valve 120 is added to the ICV inflow steam A7 and drives the intermediate/low-pressure turbine 103bc. Corresponding to the increased amount of the ICV inflow steam A7, the opening degree of the intermediate-pressure turbine bypass control valve 120 decreases by the pressure control and the intermediate-pressure bypass steam A8 decreases. However, the intermediate-pressure turbine bypass control valve 120 is still in the intermediately opened state, the intermediate-pressure bypass steam A8 is continuously flowed into the steam condenser 113.

Here, the phenomenon that the flow rate ratio becomes greater than 1:1 as described above will be described in more detail. The flow rates of the steams A7, A6, and A5 satisfy the following relationship (1).

ICV inflow steam A7+Intermediate-pressure bypass steam A6=MCV inflow steam A5+High-pressure bypass steam A6 (1)

Since the high-pressure turbine bypass control valve 119 is slightly opened due to the shortage of heat quantity, the amount of the high-pressure bypass steam A6 is small. Therefore, the above formula (1) can be approximated by the following formula (2).

ICV inflow steam A7+Intermediate-pressure bypass steam A6 MCV inflow steam A5 (2)

When the intermediate-pressure turbine bypass control valve 120 is intermediately opened, the intermediate-pressure bypass steam A6 is equal to or greater than zero. Therefore, the following relationship (3) is satisfied, and the flow rate ratio becomes greater than 1:1.

Flow rate of ICV inflow steam A7<Flow rate of MCV inflow steam A5 (3)

When the intermediate-pressure turbine bypass control valve 120 is fully closed and the intermediate-pressure bypass steam A6 becomes zero, A7 and A5 are equal to each other and the flow rate ratio becomes approximately 1:1.

(δ) Adjustment of Fixed Opening Degree at Initial Load of 30 MW

By the above (γ), the opening degree of the high-pressure turbine bypass control valve 119 is restored, and the heat quantity shortage problem occurring in the comparable example can be eliminated. However, it is necessary to pay attention to the temperature rise of the high-pressure turbine exhaust steam A3, because it is in a trade-off relationship with the control of the opening degree of the high-pressure turbine bypass control valve 119. More specifically, when the MCV inflow steam A5 decreases due to the above-described operation, the high-pressure turbine exhaust steam A3 decreases correspondingly and the temperature of the high-pressure turbine exhaust steam A3 increases due to windage loss (frictional heat). If the temperature deviates from an allowable range, the high-pressure turbine 103a may be damaged. However, as described above, it is extremely difficult to evaluate on paper the windage loss generated at the final-stage moving blade of the high-pressure turbine 103a and calculate in advance the MCV inflow steam A5 that can avoid the windage loss. This means that it is difficult to obtain an appropriate fixed opening degree by calculation. That is, the fixed opening degree of 15% used above is merely an example for the sake of convenience of explanation, and it is necessary to turn to the validity of the value of 15%.

Therefore, in the present embodiment, it is assumed that the above-described fixed opening degree is a variable value that can be adjusted by a user according to the following (4) “Trial approach”. In short, while the power plant 100a is actually operated at 30 MW to perform the initial load heat soak, the fixed opening degree of 15% can be adjusted, for example, to decrease to 14% or increase to 16% on a trial basis. This makes it possible to increase or decrease the flow rate of the MCV inflow steam A5 and to seek an optimum trade-off between the control of the opening degree of the high-pressure turbine bypass control valve 119 and the control of the flow rate of the MCV inflow steam A5. Fortunately, the initial load heat soak of the present embodiment has enough time to perform a plurality of trials. As described above, the fixed opening degree of the present embodiment is the variable value that enables a user to change a certain setting value (e.g., 15%) to another setting value (e.g., 14% or 16%).

The input device 212 is provided to perform this simply and with less labor. The input device 212 is a device (setter) that enables a user to manually select and input a value of the fixed opening degree, and can increase or decrease the value of the fixed opening degree B4 that is an output of the analog memory 211. A selector station, an operation panel, and a personal computer connected to the plant control apparatus 101a are examples of the input device 212. The input device 212 may be a device that configures the plant control apparatus 101a, or may be another device other than the plant control apparatus 101a.

The input device 212 includes the push button (up button) 212a for increasing the value of the fixed opening degree B4, the push button (down button) 212b for decreasing the value of the fixed opening degree B4, and the display device 212c for displaying the value of the fixed opening degree B4. The push buttons 212a and 212b may be hard keys or may be soft key responsive to a mouse operation or a touch operation. An electric bulletin board and a liquid crystal screen are examples of the display device 212c.

The analog memory 211 acquires an increment command from the push button 212a via the I port (Increase Port), and increases the fixed opening degree B4 according to the increment command. Further, the analog memory 211 acquires a decrement command from the push button 212a via the D port (Decrease Port), and decreases the fixed opening degree B4 according to the decrement command.

(4) Trial Approach

Hereinafter, a process of obtaining an optimum value of the fixed opening degree B4 through some trial approaches in the present embodiment will be described. In this case, using the concept of the above-described virtual initial load control facilitates the understanding. Therefore, this is used in the following description. The numerical values of the fixed opening degree B4 and the intermediate-low TBN output (B) described below are merely examples for making it easy to understand the description and are not limited thereto.

(4a) Trial at Fixed Opening Degree B4=15%

First, an initial trial is performed with the fixed opening degree B4=15% corresponding to the initial value. The value 15% is set in the setter 210, and the analog memory 211 outputs 15% as the fixed opening degree B4. In this state, the power plant 100a is activated. The ventilation of the steam turbine 103 is started and the speed is increased. After reaching the rated rotational speed, the generator breaker 125 is dosed and the ST generator 124 is brought into the breaker close operation. The MCV valve 105 starts the initial load control, and the output increases to the initial load of 30 MW, and after reaching 30 MW, the initial load heat soak operation is started. At this time, the opening degree of the B-ICV valve 118b is 15%, and the intermediate-low TBN output (B) is 12 MW. Therefore, the virtual initial load control has a setting value of 18 MW. The output of the high-pressure turbine 103a (hereinafter, referred to as high TBN output) and the intermediate-low TBN output (A) are 18 MW in total.

Since the flow rate of the MCV inflow steam A5 is smaller in the present embodiment than in the comparable example, the high-pressure turbine bypass control valve 119 takes a relatively large opening degree at which the pressure control can be performed stably. However, it increases the windage loss (frictional heat) at the same time. Therefore, it is necessary to pay attention to the temperature of the high-pressure turbine exhaust steam A3. In this case, the rise in the exhaust gas temperature due to the frictional heat responds and settles with a delay of approximately five minutes. If the temperature rise is observed after the trial at the fixed opening degree B4=15%, it means that the flow rate of the high-pressure turbine exhaust steam A3 (the flow rate of the MCV inflow steam A5) is excessively small. At the same time, it means that the setting value of the virtual initial load control of 18 MW is excessively low. Therefore, a trial at the fixed opening degree B4=13% is performed in the following (4b). Although the fixed opening degree is only reduced by 2%, a characteristic curve of ICV valve opening degree vs flow rate is generally sharp in a relatively low opening degree region. A relatively large flow rate change occurs even when the variation in the opening degree is approximately 1% or 2%.

It is desirable that the power plant 100a includes a plurality of temperature sensors (not illustrated) to check the temperature of the high-pressure turbine exhaust steam A3.

(4b) Trial at Fixed Opening Degree B4=13%

During the initial load heat soak, the fixed opening degree B4 is reduced from 15% to 13% using the input device 212. At this time, the display device 212c that displays the value of the fixed opening degree B4 may be a digital display device so that a user can accurately read the fixed opening degree B4.

When the fixed opening degree B4 is set to 13%, the opening degree of the B-ICV valve 118b becomes 13% and the intermediate-low TBN output (B) decreases to 9 MW. This causes the virtual initial load control to have a setting value of 21 MW, which acts to increase the sum of the high TBN output and the intermediate-low TBN output (A) from 18 MW to 21 MW, and increases the opening degree of the MCV valve 105. As a result, the flow rate of the MCV inflow steam A5 (the flow rate of the high-pressure turbine exhaust steam A3) increases, and the windage loss decreases. The temperature of the high-pressure turbine exhaust steam A3 decreases.

However, at this time, it is necessary to pay attention to the opening degree of the high-pressure turbine bypass control valve 119. If the high-pressure turbine bypass control valve 119 has an unacceptably slight opening degree (in general, 5% or less) as a result of the increase in the flow rate of the MCV inflow steam A5, it means that the setting value of the virtual initial load control at 21 MW is excessively high. Therefore, a trial at the fixed opening degree B4=14% is performed next.

(4c) Trial at Fixed Opening Degree B4=14%

During the initial load heat soak, the fixed opening degree B4 is increased from 13% to 14% using the input device 212. When the fixed opening degree B4 is set to 14%, the opening degree of the B-ICV valve 118b becomes 14% and the intermediate-low TBN output (B) increases to 10 MW. This causes the virtual initial load control to have a setting value of 20 MW, which acts to reduce the sum of the high TBN output and the intermediate-low TBN output (A) from 21 MW to 20 MW, and reduces the opening degree of the MCV valve 105. As a result, the flow rate of the MCV inflow steam A5 decreases, and the opening degree of the high-pressure turbine bypass control valve 119 is restored to 5% or more. At this time, the temperature of the high-pressure turbine exhaust steam A3 rises from the (4b) trial at the opening degree 13%, but if the temperature rise is within an allowable range, the fixed opening degree B4=14% is an optimum fixed opening degree and the intended trade-off is established here.

In the above-described procedure, the fixed opening degree B4 is changed in steps of 1% in the vicinity of 14%, but may be changed more finely. For fine tuning, it is possible to perform the trial by setting the fixed opening degree B4 to, for example, 13.8% or 14.1%.

(4d) after Termination of the Initial Load Heat Soak

During the initial load heat soak, it is necessary to maintain the generator MW of 30 MW to reduce the thermal stress. On the other hand, when the initial load heat soak is terminated, the steam turbine 103 is allowed to operate at an output exceeding 30 MW. Therefore, when the termination of the initial load heat soak is detected, the opening degree of the B-ICV valve 118b gradually increases from the 14% opening degree to the 100% full opening. Similarly, the A-ICV valve 118a is released from the 2:1 flow rate control, and the opening degree gradually increases to the 100% full opening from the opening degree B2 of the 2:1 flow rate control. When the opening degrees of these ICV valves 118a/b become 100% full opening, these ICV valves 118a/b have the same opening degree again and return to their ordinary states. Subsequently, the gas turbine 102 starts increasing its output, which is the next step of plant activation, and the power plant 100a reaches the rated output (completes activation).

(5) Effects of First Embodiment

As described above, the first embodiment can eliminate the contradictory problems of (i) temperature rise of the high-pressure turbine exhaust steam A3 and (ii) heat quantity shortage of the main steam A2, by setting one ICV to the fixed opening degree, and enables the power plant 100a to efficiently use the steam. The first embodiment further makes it possible to obtain the optimum fixed opening degree through a trial approach while actually operating the power plant 100a, by setting the fixed opening degree to a variable value using the input device 212.

If an object to be adjusted by a user is, for example, an internal parameter of a control apparatus program, selecting such a value is extremely difficult for the user. However, the object to be adjusted by the user in the present embodiment is not such a difficult object but the opening degree of the B-ICV valve 118b (tangible object). Therefore, the selection of the value is easy for the user to understand and the trial is easy correspondingly.

(6) Consideration on First Embodiment

The background of the trial approach is that it is difficult to evaluate in advance the temperature rise of the high-pressure turbine exhaust steam A3 by calculating on paper the windage loss. This has been described as being mainly related to the problem (i). However, the problem (i) and the problem (ii) are similar in that both are difficult to calculate on paper. This results from numerous drain valves (not illustrated in the drawings) installed in pipes and steam turbine machines. At an extremely low output including the initial load heat soak, these drain valves are open-operated to discharge the residual drain water to the steam condenser or the like. However, not only the drain water but also the main steam A2 and (a part of) the reheat steam A4 are discharged together from these drain valves, so that a so-called two-phase gas-liquid stream flows out. This outflow further worsens the heat quantity shortage problem, but it is extremely difficult to calculate how much steam or heat quantity will flow out of the drain valve (for reasons such as two-phase stream). Accordingly, in recent years, computer-based simulation techniques and the like have highly advanced. On the other hand, it is recognized as a fact that the operation state at an extremely low output is “unknown until the power plant is actually operated”.

In order to work on the problems (i) and (ii) exhibiting the chaotic aspect, it will be understood that the present embodiment in which the optimum fixed opening degree is obtained on a trial basis while actually operating the power plant 100a is a very pragmatic (practical) and reasonable method. In the present embodiment, “the fixed opening degree of one ICV valve” is selected as an adjustment object when performing the “trial approach”. This results in a relatively simple control circuit and provides an indication that is easy to understand for a user who performs the trial, but has a greater influence than its simple appearance at the same time. Hereinafter, further characteristic points of the present embodiment will be described in comparison with another control methods.

(6a) Another Control Method-1

The first example is a method for setting “both ICV valves to a fixed opening degree”. That is, not only the opening degree of the B-ICV valve 118b but also the opening degree of the A-ICV valve 118a are fixed. In this case, since the output of the intermediate/low-pressure turbine 103bc becomes constant, the initial load control is performed by the MW control in which only the MCV valve 105, that is, only the output of the high-pressure turbine 103a, responds.

On the other hand, in “the fixed opening degree of one ICV valve” of the present embodiment, the A-ICV valve 118a is linked with the MCV valve 105 under the 2:1 flow rate control. Therefore, in the MW control, all the steam turbines 103 including not only the high-pressure turbine 103a but also the intermediate/low-pressure turbine 103bc respond and try to follow up the load demand. This is desired behavior and operation of the MW control, and is a basic control concept. The reason why the bi-valved ICV valves are employed in the present embodiment is related to this point.

In the first place, the idea of fixing the ICV valve opening degree cannot be applied to a power plant in which a uni-valved ICV valve is installed. This is because fixing the opening degree of the uni-valved ICV valve is comparable with fixing the opening degrees of both the bi-valved ICV valves of the present embodiment. In this case, the basic concept is failed in that only the high-pressure turbine 103a responds to the load, and it is unacceptable to adopt this. Only in the case of bi-valved ICV valves, as in the present embodiment, while one valve (118b) secures a bias output with a fixed opening degree, the other valve (118a) can respond to a load in an interlocking manner.

(6b) Another Control Method-2

Although the operation realized by the first embodiment is an operating method that falls within the range between the 2:1 flow rate control and the 1:1 flow rate control, this may be realized by another control method. An example is N:1 flow rate control (N is an integer satisfying 1≤N≤2). For example, when the value of N is specified as 1.5, the N:1 flow rate control is 1.5:1 flow rate control. In this control, the function F(x) is set so that the flow rate ratio of the MCV inflow steam A5 to the ICV inflow steam A7 becomes 1.5:1, and the opening degree of the ICV valve 118a/b is reduced. However, like the 2:1 flow rate control, determining the function F(x) in the 1.5:1 flow rate control requires a large amount of labor. Further, in this case, the number of functions F(x) required to perform the trial approach is N. For example, if the value of N is determined with the accuracy ranging the second decimal place (N=1.01 to 1.99), as many as 98 functions F(x) and the switching/selection will be required.

(6c) N:1 Flow Rate Control of First Embodiment

Here, it should be noted that the flow rate control of the first embodiment is also a type of the N:1 flow rate control (N is an integer satisfying 1<N<2). This is because what is realized in the present embodiment is an operating method that falls within a range between the 2:1 flow rate control and the 1:1 flow rate control. However, if the example of (6b) is regarded as an N:1 flow rate control in a narrow sense because of specifying the value of N, the present embodiment can be regarded as an N:1 flow rate control in a broad sense because the value of N is not specified. The N:1 flow rate control of (6b) suggests that the trial approach is burdensome for the plant control. In other words, the N:1 flow rate control is unavoidably complicated when performing the trial approach. In some cases, this impairs the applicability of the control circuit to a real facility.

To the contrary, the control circuit of the first embodiment is remarkably simple. The control circuit of the present embodiment has a basic configuration that is based on the 2:1 flow rate control, and is a type of modified circuit in which the switcher 213 and the analog memory 211 are added to the basic configuration. This is highly compatible with the 2:1 flow rate control, and provides a simple circuit configuration in the present embodiment. This is also desirable in that the property of the 2:1 flow rate control software program can be utilized.

In the present embodiment, instead of specifying the value of N and setting it as a variable value as in the example of (6b), the fixed opening degree of the ICV valve is specified and is set as a variable value. For example, the present embodiment specifies the value of the fixed opening degree as 14% or 15%, and consequently realizes an N:1 flow rate control derived from the value of N corresponding to the fixed opening degree of 14% or 15%. Further, adjusting the fixed opening degree of the ICV valve on a trial basis in the present embodiment corresponds to adjusting the value of N. If described according to this context, it is summarized that the first embodiment intends to provide the N:1 flow rate control in which specifying N is abandoned and, in return for it, obtains simplicity and practicability.

(7) Limitations in Adjustment

The above-described trial approach procedure (4c) is the case in which the fixed opening degree of 14% can be selected as an optimum fixed opening degree while achieving the trade-off. However, even when the fixed opening degree is adjusted so as to avoid the “temperature rise of high-pressure turbine exhaust steam” and the “slight opening of high-pressure turbine bypass control valve”, it may be difficult in some cases to simultaneously solve both of these problems. Therefore, it is desirable that the power plant 100a of the present embodiment adopts a so-called contingency plan (evacuation measure) in preparation for such a case. This plan includes, for example, increasing the output of the gas turbine 102 to increase the heat quantity of the exhaust gas A1 so that the flow rate of the main steam A2 increases. By such a measure, the opening degree of the high-pressure turbine bypass control valve 119 increases and accordingly it becomes possible to easily select the optimum fixed opening degree. However, in this case, the temperature of the exhaust gas A1 becomes higher and the thermal stress of the steam turbine 103 becomes greater. Therefore, it should be noted that a trade-off is forced in activating the plant.

(8) Power Plant to which First Embodiment is Applicable

In the present embodiment, the separate-shaft combined cycle power plant 100a that has the cascade bypass system and combines one gas turbine 102 and one steam turbine 103 with the separate-shaft configuration has been described. However, the present embodiment is also applicable to another type of combined cycle power plant that has a cascade bypass system. Representatively, the present embodiment is applicable to a multiaxial combined cycle power plant (in which one steam turbine is combined with a plurality of gas turbines with the separate-shaft configuration).

For example, there is a so-called “3on1 type” multiaxial combined cycle power plant that combines three gas turbines, three exhaust heat recovery boilers, and one steam turbine. Even in such a power plant, the initial load heat soak operation of the steam turbine is performed in its activation stage. However, in this case, the operation is performed by combining one gas turbine, one exhaust heat recovery boiler, and one steam turbine. The remaining two gas turbines (and two exhaust heat recovery boilers) do not contribute to the initial load heat soak operation at all. That is, at the time of the initial load heat soak operation, the plant configuration thereof is the same as that of the separate-shaft combined cycle power plant, and accordingly the present embodiment can be applied directly.

When comparing the steam turbine capacity (size) with the quantity of heat supplied by the gas turbine, one steam turbine having a capacity corresponding to the heat quantity of one gas turbine is used in the separate-shaft type of the first embodiment. On the other hand, a large steam turbine corresponding to the heat quantity of three gas turbines is used in the 3on1 multiaxial type. When it is attempted to use only one gas turbine for the initial load heat soak of the steam turbine that is three times larger than that of the present embodiment, the tendency of the heat quantity shortage described in the present embodiment becomes a more serious problem. Specifically, the shortage of heat quantity may occur not only at the time of cold start described above but also at the time of warm start or hot start in which the temperature of the gas turbine exhaust gas A1 becomes higher. Applying the present embodiment to such situations is very effective.

Further, the present embodiment is applicable to a uniaxial combined cycle power plant in which one gas turbine and one steam turbine are coaxially configured.

Examples of the uniaxial combined cycle power plant include a rigid coupling type in which a gas turbine and a steam turbine are fixed and coaxial, and a clutch coupling type in which a gas turbine and a steam turbine are coupled with a clutch. However, in each type, since one generator is shared by the gas turbine and the steam turbine, an MW transducer measures the generator MW generated by the total output of both turbines. Therefore, the MW transducer cannot obtain the electric power (MW) generated by the steam turbine alone as a measurement value.

Therefore, when the power plant 100a of the present embodiment is a uniaxial type, the initial load control of the MCV valve 105 is performed so as to control the output of the steam turbine 103 alone to 30 MW using the output of the steam turbine 103 alone calculated by the plant control apparatus 101a, instead of using the generator MW measured by the MW transducer MW-Tr. To calculate the output of the steam turbine 103 alone, although not illustrated in FIG. 1, measurement signals from sensors that measure the pressure, flow rate, and temperature of various measurement objects representing an operation state of the steam turbine 103 are input to the plant control apparatus 101a. Then, the plant control apparatus 101a calculates the output of the steam turbine 103 alone based on these measurement signals.

(9) Application to Steam Power Generation Plant

The present embodiment is applicable to not only combined cycle power plants but also steam power generation plants. The steam power generation plant includes an ordinary boiler instead of the exhaust heat recovery boiler 104 that receives the exhaust gas A1 from the gas turbine 102, and this boiler generates main steam. The steam power generation plant has a larger capacity than that of the combined cycle power plant. In general, the large-capacity steam turbine includes bi-valved ICV valves. In addition, the cascade bypass system configuration, the initial load heat soak activation method, and the 2:1 flow rate control, which are essential factors for realizing the present embodiment, can be implemented and applied to steam power generation plants. It is rather appropriate to think that these are originally designed for steam power generation plants and are later applied to combined cycle power plants. Accordingly, no problem arises in the steam power generation plant when applying the present embodiment in which one of two ICV valves is set to the fixed opening degree. This applies not only to the present embodiment but also to the second embodiment described below.

As described above, when adjusting the total output of the high-pressure turbine 103a, the intermediate-pressure turbine 103b, and the low-pressure turbine 103c to 30 MW, the plant control apparatus 101a of the present embodiment controls the A-ICV valve 118a and the B-ICV valve 118b to different opening degrees. For example, while controlling the B-ICV valve 118b to the fixed opening degree, the plant control apparatus 101a changes the A-ICV valve 118a with time elapsed. Therefore, according to the present embodiment, it becomes possible to efficiently use steam for driving the steam turbine 103 and the like in combined cycle power plants and other power plants.

### Second Embodiment

(1) Overview

In the second embodiment, a user can select (switch), using a select switch, either one of the above-described two ICV valves 118a/b as a valve to which the fixed opening degree is applied. Even when the bi-valved ICV valves 118a/b are opened at different opening degrees, no problem arises in the operation of the steam turbine 103, as described above.

However, from the viewpoint of the durability of the ICV valves 118a/b, it is not desirable the valve to which the fixed opening degree is applied is unchanged. In the initial load heat soak of the first embodiment, the opening degree of the A-ICV valve 118a is continuously controlled to the opening degree that is smaller than the opening degree of the B-ICV valve 118b. As a result, the pressure loss inside the valve body of the A-ICV valve 118a increases, and the life consumption of the A-ICV valve 118a proceeds more quickly. Although the difference in life consumption is small, when the service life of 10 years or 20 years is taken into consideration, a request from the power plant owner side to equalize the life consumption in respective ICV valves 118a/b may be presented. The second embodiment copes with this.

(2) Configuration

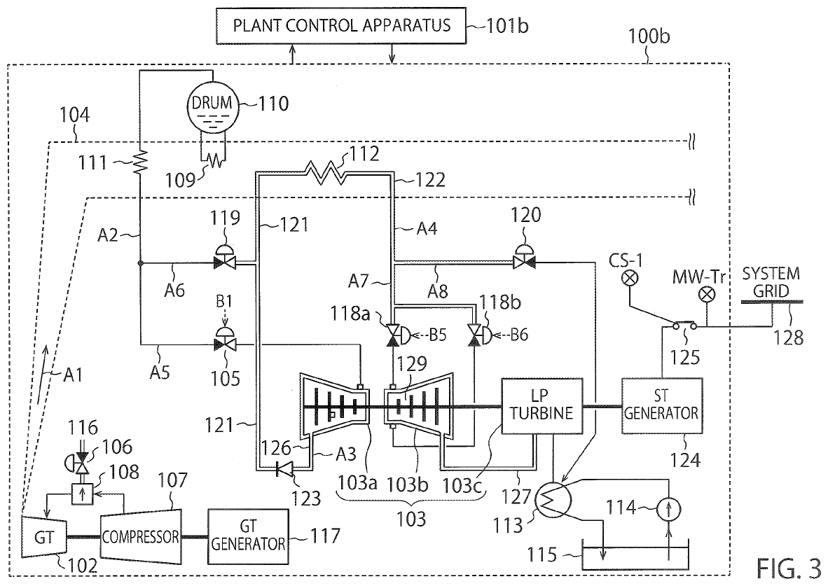

FIG. 3 is a schematic diagram illustrating a configuration of a power plant 100b of the second embodiment.

The power plant 100b illustrated in FIG. 3 includes a plant control apparatus 101b that controls operations of the power plant 100b and further includes constituent components (gas turbine 102, steam turbine 103, exhaust heat recovery boiler 104, and the like) similar to those of the power plant 100a illustrated in FIG. 1. In addition, the plant control apparatus 101b illustrated in FIG. 3 includes a control circuit that performs flow rate control different from the flow rate control of the plant control apparatus 101 illustrated in FIG. 1. To this end, in FIG. 3, the opening degree command [%] of the A-ICV valve 118a is “B5” that is replaced from “B2”, and the opening degree command [%] of the B-ICV valve 118b is “B6” that is replaced from “B3”.

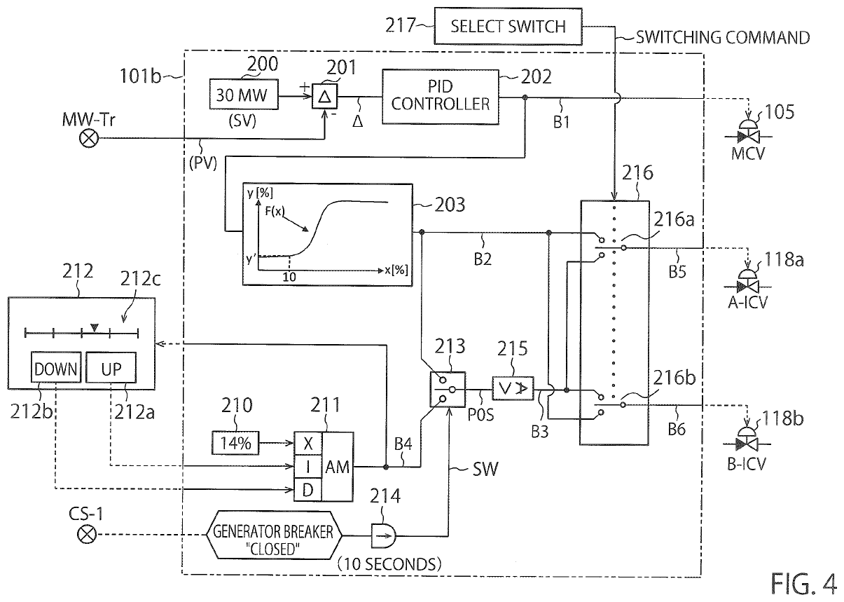

FIG. 4 is a circuit diagram illustrating a configuration of the plant control apparatus 101b of the second embodiment.

The plant control apparatus 101b of the present embodiment includes, in addition to the constituent components (see FIG. 2) of the plant control apparatus 101a of the first embodiment, a switcher 216 and a select switch 217. The select switch 217 may be a device that configures the plant control apparatus 101b or may be another device that is different from the plant control apparatus 101b. Further, the select switch 217 may be a hard key or may be a soft key that is responsive to a mouse operation or a touch operation. For example, the select switch 217 may be a so-called alternative type push button, and may be configured such that the switcher 216 is switched every time this push button is operated. The switcher 216 is an example of a selection module, and the select switch 217 is an example of a selection device. Configurations and functions relating to an initial load control of the plant control apparatus 101b of the present embodiment are similar to those of the plant control apparatus 101a of the first embodiment.

An opening degree command value B2 generated by the plant control apparatus 101b of the present embodiment is similar to that of the first embodiment. The generated opening degree command value B2 is input to a first switching unit 216a and a second switching unit 216b that are incorporated in the switcher 216.

An opening degree command value B3 generated by the plant control apparatus 101b of the present embodiment is also similar to that of the first embodiment. However, reflecting the result of the trial approach, the setting value is set to 14% instead of 15% in the setter 210. The generated opening degree command value B3 is input to the first switching unit 216a and the second switching unit 216b.

The first switching unit 216a outputs the opening degree command value B5 for the A-ICV valve 118a, and the second switching unit 216b outputs the opening degree command value B6 for the B-ICV valve 118b. The opening degree command values B5 and B6 will be described in detail below.

(3) Functions

First, the first switching unit 216a and the second switching unit 216b of the switcher 216 are in a switching state in which the same ICV valve control as that of the first embodiment is performed. That is, the first switching unit 216a is in a state of selecting the opening degree command value B2 (2:1 flow rate control) as the opening degree command value B5 for the A-ICV valve 118a, and the second switching unit 216b is in a state of selecting the opening degree command value B3 (fixed opening degree) as the opening degree command value B6 for the B-ICV valve 118b.

In this state, the first activation of the power plant 100b is performed. Subsequently, the ventilation of the steam turbine 103 is started and the speed increases. After the speed reaches the rated rotational speed, the generator breaker 125 is closed and the ST generator 124 is brought into the breaker close operation. The MCV valve 105 starts the initial load control, and the generator MW increases to the initial load of 30 MW. After the generator MW reaches 30 MW, the initial load heat soak is started. At this time, the A-ICV valve 118a is under the 2:1 flow rate control, and the B-ICV valve 118b is at the fixed opening degree (14%). The above is the same as the first embodiment (except that the fixed opening degree is 14%). After termination of the initial load heat soak, the power plant 100b is continuously activated and reaches a rated output state. Subsequently, the power plant 100b continues its operation while adjusting the load according to the power demand and supply balance. Then, the power plant 100b is stopped according to an operation plan.

In a state where the power plant 100b is stopped, a user operates the select switch 217. As a result, a switching command for switching the setting of the first switching unit 216a and the second switching unit 216b is output from the select switch 217 to the switcher 216. In response to the switching command, the switcher 216 switches to the position opposite to that of the above-described first embodiment. That is, the first switching unit 216a selects the opening degree command value B3 (fixed opening degree) as the opening degree command value B5 for the A-ICV valve 118a. The second switching unit 216b selects the opening degree command value B2 (2:1 flow rate control) as the opening degree command value B6 for the B-ICV valve 118b.

In this state, the second activation of the power plant 100b is performed. When the initial load heat soak operation is started, the A-ICV valve 118a is held at the fixed opening degree (14%), and the B-ICV valve 118b is under the 2:1 flow rate control. That is, in the second activation, the behavior of both the ICV valves 118a/b is switched between the A-ICV valve 118a and the B-ICV valve 118b.

Then, after the power plant 100b is stopped, the user operates the select switch 217 again. When the third activation of the power plant 100b is performed in this state, the behavior of both the ICV valves 118a/b is switched between the A-ICV valve 118a and the B-ICV valve 118b. In other words, the behavior in the third activation is the same as that in the first activation.

As described above, performing the switching using the select switch 217 during each power plant stop period can equalize the life consumption of both the ICV valves 118a/b. The timing at which the user performs the switching operation using the select switch 217 is not limited to the stop period of the power plant 100b. For example, after termination of the initial load heat soak described above in (4d), the operation for switching between the A-ICV valve 118a and the B-ICV valve 118b may be performed when both the ICV valves 118a/b are fully opened (100%).

(4) Modified Example of Second Embodiment

The switcher 216 of the present embodiment may receive a stop signal of the power plant 100b (e.g., a turbine trip signal of the steam turbine 103), instead of the above-described switching command, and may perform switching according to the stop signal in the same manner as in the case of receiving the switching command. When the next activation of the power plant 100b is performed in this state, the behavior of both the ICV valves 118a/b is switched between the A-ICV valve 118a and the B-ICV valve 118b. Accordingly, the switching of the ICV valves 118a/b can be automated, and the user's operation using the select switch 217 can be performed with reduced labor. In this case, the switcher 216 automatically switches the ICV valves 118a/b in response to the reception of the stop signal.

Although it is desirable to perform the automatic switching of the ICV valves 118a/b during the stop period of the power plant 100b, the automatic switching may be performed at another timing, for example, during the initial load heat soak. However, in this case, it is necessary to introduce a compensation control for maintaining the generator MW of 30 MW in the process of switching both the ICV valves 118a/b. Since the compensation control is complicated, if simplification of the control circuit is desired, it is desirable to perform the automatic switching of the ICV valves 118a/b during the stop period of the power plant 100b.

As described above, the plant control apparatus 101b of the present embodiment makes it possible to switch manually or automatically when determining either one of the ICV valves 118a/b to which the 2:1 flow rate control is applied and when determining either one of the ICV valves 118a/b to which the fixed opening degree is applied. Therefore, according to the present embodiment, it is possible to reduce the difference in type of usage between the A-ICV valve 118a and the B-ICV valve 118b. This makes it possible to equalize the life consumption of both the ICV valves 118a/b.

While certain embodiments have been described, these embodiments have been presented by way of example only, and are not intended to limit the scope of the inventions. Indeed, the novel apparatus, methods and plants described herein may be embodied in a variety of other forms; furthermore, various omissions, substitutions and changes in the form of the apparatus, methods and plants described herein may be made without departing from the spirit of the inventions. The accompanying claims and their equivalents are intended to cover such forms or modifications as would fall within the scope and spirit of the inventions.

1. A plant control apparatus configured to control a power plant, the plant comprising:
a gas turbine;
an exhaust heat recovery boiler configured to generate main steam by using heat of exhaust gas from the gas turbine;
a first steam turbine configured to be driven by first steam that is a part of the main steam;
a first valve configured to supply the first steam to the first steam turbine;
a first bypass valve configured to adjust first bypass steam that is another part of the main steam and bypasses the first steam turbine;
a reheater provided in the exhaust heat recovery boiler and configured to generate reheat steam by heating the first steam discharged from the first steam turbine and the first bypass steam having bypassed the first steam turbine by using heat of the exhaust gas;
a second steam turbine configured to be driven by second steam that is a part of the reheat steam;
second and third valves configured to supply the second steam to the second steam turbine; and
a second bypass valve configured to adjust second bypass steam that is another part of the reheat steam and bypasses the second steam turbine,
the apparatus comprising:
an acquisition module configured to acquire a setting value of total output of the first and second steam turbines; and
a control module configured to adjust the total output to the setting value by controlling opening degrees of the first, second and third valves,
wherein the control module is configured to control the second and third valves to different opening degrees when adjusting the total output to the setting value.

2. The apparatus of claim 1, wherein the second and third valves are arranged in parallel with each other between the reheater and the second steam turbine.

3. The apparatus of claim 1, wherein the control module controls the opening degree of one of the second and third valves to a fixed opening degree.

4. The apparatus of claim 3, wherein the control module acquires a value of the fixed opening degree input to an input device by a selection operation for selecting the value of the fixed opening degree, and controls the opening degree of one of the second and third valves to the value of the fixed opening degree input to the input device.

5. The apparatus of claim 4, wherein the control module adjusts at least one of a flow rate of the first steam passing through the first valve and an opening degree of the first bypass valve, by controlling the opening degree of one of the second and third valves to the value of the fixed opening degree input to the input device.

6. The apparatus of claim 3, wherein the control module adjusts the total output to the setting value by changing the opening degree of the first valve, controlling the opening degree of one of the second and third valves to the fixed opening degree, and changing the opening degree of the other of the second and third valves.

7. The apparatus of claim 3, wherein the control module controls the opening degree of one of the second and third valves to the fixed opening degree, and controls the opening degree of the other of the second and third valves to an opening degree smaller than the fixed opening degree.

8. The apparatus of claim 3, further comprising a selection module configured to select one of the second and third valves,
wherein the control module controls the opening degree of the valve selected by the selection module to the fixed opening degree.

9. The apparatus of claim 8, wherein the selection module selects one of the second and third valves based on a command from a selection device provided for inputting a selection operation for selecting one of the second and third valves.

10. The apparatus of claim 8, wherein the selection module automatically switches the valve selected between the second and third valves from one valve to the other valve at predetermined timing.

11. A plant control apparatus configured to control a power plant, the plant comprising:
a boiler configured to generate main steam;
a first steam turbine configured to be driven by first steam that is a part of the main steam;
a first valve configured to supply the first steam to the first steam turbine;
a first bypass valve configured to adjust first bypass steam that another part of the main steam and bypasses the first steam turbine;
a reheater provided in the boiler and configured to generate reheat steam by heating the first steam discharged from the first steam turbine and the first bypass steam having bypassed the first steam turbine;
a second steam turbine configured to be driven by second steam that is a part of the reheat steam;
second and third valves configured to supply the second steam to the second steam turbine; and
a second bypass valve configured to adjust second bypass steam that is another part of the reheat steam and bypasses the second steam turbine,
the apparatus comprising:
an acquisition module configured to acquire a setting value of total output of the first and second steam turbines; and
a control module configured to adjust the total output to the setting value by controlling opening degrees of the first, second and third valves,
wherein the control module is configured to control the second and third valves to different opening degrees when adjusting the total output to the setting value.

12. A plant control method of controlling a power plant, the plant comprising:
a gas turbine;
an exhaust heat recovery boiler configured to generate main steam by using heat of exhaust gas from the gas turbine;
a first steam turbine configured to be driven by first steam that is a part of the main steam;
a first valve configured to supply the first steam to the first steam turbine;
a first bypass valve configured to adjust first bypass steam that is another part of the main steam and bypasses the first steam turbine;
a reheater provided in the exhaust heat recovery boiler and configured to generate reheat steam by heating the first steam discharged from the first steam turbine and the first bypass steam having bypassed the first steam turbine by using heat of the exhaust gas;
a second steam turbine configured to be driven by second steam that is a part of the reheat steam;
second and third valves configured to supply the second steam to the second steam turbine; and
a second bypass valve configured to adjust second bypass steam that is another part of the reheat steam and bypasses the second steam turbine,
the method comprising:
acquiring a setting value of total output of the first and second steam turbines; and
adjusting the total output to the setting value by controlling opening degrees of the first, second and third valves, wherein the second and third valves are controlled to different opening degrees when the total output is adjusted to the setting value.

13. A power plant comprising:
a gas turbine;
an exhaust heat recovery boiler configured to generate main steam by using heat of exhaust gas from the gas turbine;
a first steam turbine configured to be driven by first steam that is a part of the main steam;
a first valve configured to supply the first steam to the first steam turbine;
a first bypass valve configured to adjust first bypass steam that is another part of the main steam and bypasses the first steam turbine;
a reheater provided in the exhaust heat recovery boiler and configured to generate reheat steam by heating the first steam discharged from the first steam turbine and the first bypass steam having bypassed the first steam turbine by using heat of the exhaust gas;
a second steam turbine configured to be driven by second steam that is a part of the reheat steam;
second and third valves configured to supply the second steam to the second steam turbine;
a second bypass valve configured to adjust second bypass steam that is another part of the reheat steam and bypasses the second steam turbine;
an acquisition module configured to acquire a setting value of total output of the first and second steam turbines; and
a control module configured to adjust the total output to the setting value by controlling opening degrees of the first, second and third valves,
wherein the control module is configured to control the second and third valves to different opening degrees when adjusting the total output to the setting value.
